(19) United States
(12) Patent Application Publication
(10) Pub. No.: US 2003/0178758 A1
(43) Pub. Date: Sep. 25, 2003

(54) Spring element

(76) Inventor: Andrzej Metelski, Romanshorn (CH)

Correspondence Address: George L. Snyder, Jr., Hodgson Russ LLP, Suite 2000, One M&T Plaza, Buffalo, NY, 14203-2391, US

(21) Appl. No.: 10/385,559

(22) Filed: Mar. 11, 2003

(30) Foreign Application Priority Data
Mar. 19, 2002 (DE) 202 04 321.5

(51) Int. Cl. F16F 1/06; F16F 1/12

(52) U.S. Cl. 267/166; 267/170

(57) ABSTRACT

A spring element has a substantially cylindrical housing (125) and at least one spring (128) arranged therein. At least one guidance member (129) that radially braces the spring (128) is arranged between an outer side of the spring (128) and an inner wall of the housing (125).

### CROSS REFERENCE TO RELATED APPLICATIONS

This application claims priority of the German utility model application 202 04 321.5 filed Mar. 19, 2002 which is incorporated by reference herein.

### FIELD OF THE INVENTION

The invention concerns a spring element, in particular for use in a stand for surgical microscopes.

### BACKGROUND OF THE INVENTION

Surgical microscopes supported by stands must be easily pivotable over a predefined range, and must retain the position that is set. A stand having a spring apparatus for weight compensation is known from DE 37 39 080 A1, in which weight compensation is implemented by combining Bowden cables with springs. This, however, involves energy assistance of a displacement movement exerted by an operator on a handle. There is no teaching in this existing art as to holding a load in a counterbalanced “floating” state, as is desirable in the case of surgical microscopes.

DE 197 42 050 A1 (1999) discloses a stand assemblage having a pivotable parallelogram carrier that is weight-compensated, by way of a Bowden cable and a weight compensation spring, in such a way that the counterweights which are additionally present can be made particularly small. In this assemblage, the Bowden cable is guided in a particular configuration in order to minimize, over a wide pivoting range of the pivot arm, the weight compensation errors resulting from the finite deflection radius. The weight compensation errors are not eliminated by this feature, however, so that in certain pivot positions it is still necessary to adjust the counterweights.

U.S. Pat. No. 6,070,839 (2000) discloses a further assemblage having a pivot arm and a Bowden cable/spring design that makes possible pure weight compensation—in the manner of the weight compensation with diagonal bracing springs mentioned above—but without contributing equalization torques in order to improve tipover resistance.

U.S. Pat. No. 5,253,832 (1999) describes a stand having a centrally arranged tension spring for weight compensation. This assemblage does not offer an easy adjustment capability for modified loads, so that changes to a microscope or to its accessories cannot readily result in an adjustment of the compensating forces. It is additionally disadvantageous that the tension spring has a different degree of compression and expansion depending on the pivot position of the carrier arm, which because of the spring characteristic results in differing compensation forces and thus in compensation behavior that differs over the pivot range of the carrier arm and is thus unusable for a user in the surgical context.

Springs are ideal for particularly high-performance weight compensation in a small space. Both tension and compression springs are suitable, depending on the installation location. Springs that apply the same force over a specific compression or expansion travel would theoretically be ideal. Such springs are not usable, however, in a comparable assemblage having comparable parameters. Conventional springs are therefore preferably used, but by means of counter-compensation in the form of cams or the like they can tolerate a movement (up-down pivoting) of the load in order always to apply the same compensation force or compensation torques.

### SUMMARY OF THE INVENTION

It is therefore the object of the present invention to implement a stand assemblage having a conventional spring, and in that context also to make possible the use of long springs.

This object is achieved, according to the present invention, by the features of claim 1. Advantageous developments of the invention are the subject matter of the dependent claims.

In order to prevent buckling of the spring under compressive load in the case of long compression springs, at least one guidance member that radially braces the spring is arranged between the outer side of the spring and the inner wall of the housing. The guidance member is advantageously sleeve-shaped.

In order to reduce friction and thus losses, it is advisable to equip the guidance member with rolling bearing elements, for example ball-bearing bushings, or to configure it as a plain bearing.

In order to influence the characteristic of the spring elements, it is advantageous if an axial stop that limits the displacement travel of the guidance member is provided.

In order to achieve nonlinear resulting spring characteristic curves, at least two compression springs, arranged axially behind one another and positioned in series, are provided, the springs being braced against one another via the axially displaceable guidance member and having identical or different spring constants.

With identical spring constants there is then an inflection in the spring characteristic curve, since when the one spring is in the unlocked state, twice the travel can be enabled for a given force, while in the locked state for the same given force, only the distance itself can be traveled. In a further advantageous embodiment, the housing is embodied as a pneumatic cylinder having a piston axially displaceable in the cylinder, the spring enclosing at least a portion of the piston. The piston can also simultaneously be embodied as a guidance element. As a result, pneumatic spring forces and/or damping elements, as in the case of a shock absorber, can be utilized in addition to the spring force.

### BRIEF DESCRIPTION OF THE DRAWINGS

The invention is presented in exemplary embodiments and will be explained in more detail with reference to the schematic drawings, in which:

FIG. 1 shows a spring element having a compression spring braced radially by a guidance element;

FIG. 2 shows a variant of the spring element depicted in FIG. 1, having two compression springs axially braced against on another via a guidance member; and

FIG. 3 shows a spring element combined with a pneumatic pressure cylinder.

### DETAILED DESCRIPTION OF THE INVENTION

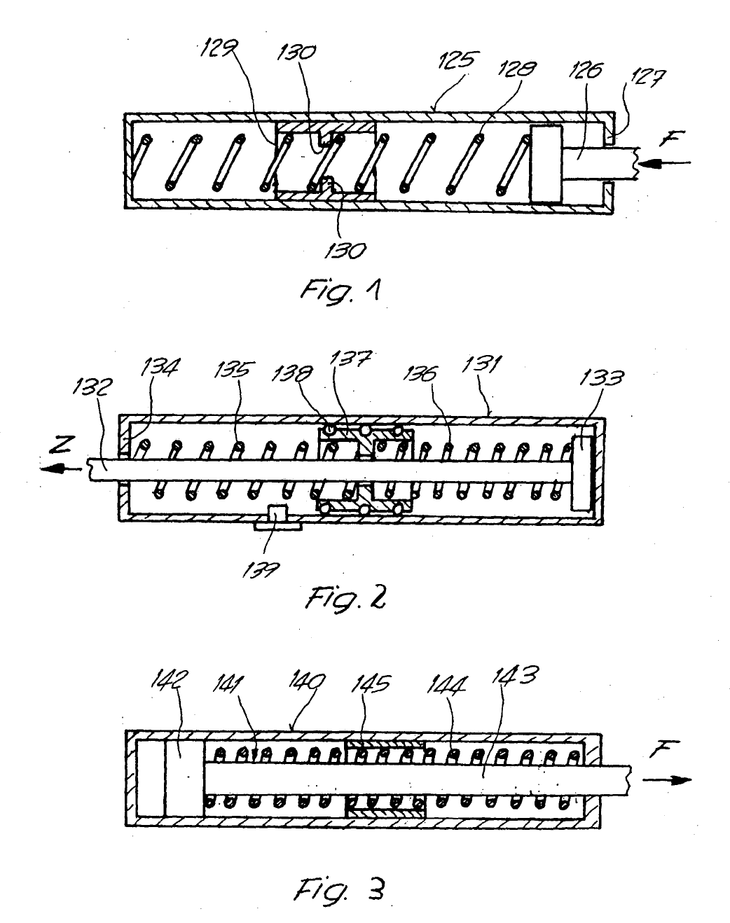

The spring element evident from FIG. 1 substantially comprises a housing 125 and a plunger 126 mounted displaceably therein. A compression spring 128 is arranged between rear end wall 127 and plunger 126. For clearer elucidation of the spring element, compression spring 128 is shown in shortened fashion. If a longer spring travel of plunger 26 is desired, compression spring 128 can also be dimensioned considerably longer. The risk then exists that compression spring 128 may buckle out radially and come into contact with the inner wall of housing 125. To prevent this, an approximately cylindrically configured, axially displaceable guidance member 129 is arranged in the central region of compression spring 128. Guidance member 129 can be made of plastic or of a bearing metal, e.g. bronze, so that defined friction conditions exist with the spring element in any service position. Guidance member 129 has two lugs 130 that engage into the turns of compression spring 128. Guidance member 129 is thus entrained upon axial contraction of compression spring 128, so that it is always located in the predefined region of compression spring 128 regardless of the compression of compression spring 128, and optimum guidance thus results. With one guidance member 129, guidance member 129 is located in the middle of spring 128; and with multiple members 129, said guidance members 129 are distributed symmetrically along the longitudinal axis of spring 128.

The spring element shown in FIG. 2 comprises a housing 131 having a tension rod 132, displaceable therein, having a head 133 of enlarged diameter. Between front end wall 134 of housing 131 and head 133, two compression springs 135 and 136 are axially braced against on another via a guidance member 137. Guidance member 137 is guided in housing 131 by way of rolling bearing elements 138, for example ball-bearing bushings, which are characterized by very low friction. Compression springs 135, 136 can have identical or different spring properties. A stop 139 is provided in housing 131. The action of compression spring 135 is limited by the arrival of guidance member 137 against stop 139. A nonlinear spring characteristic over the entire spring travel of compression springs 135, 136 can thus be achieved. Stop 139 can, however, also be releasable, so that the spring characteristic curve of the system can be influenced.

The spring element evident from FIG. 3 comprises a cylinder 140 having a pneumatic piston 141. The spring element thus constitutes a system similar to a bicycle pump. Piston 141 has a head 142 and a shaft 143 with reduced diameter as compared to the latter. Shaft 143 is surrounded by a compression spring 144, head 142 of piston 141 being braced in the axial direction against compression spring 144. In its central region, compression spring 144 is radially braced in cylinder 140 via a sleeve-shaped guidance member 145. Upon compression of compression spring 144, guidance member 145 can co-move axially as a result of friction or, as in FIG. 1, can be connected via lugs 130 or other driver elements to the turns of compression spring 144. Cylinder 140 and piston 141 coact in the manner of a gas spring. The desired spring characteristic curve of the overall spring element can be achieved by coordinating the spring characteristic of this gas spring with the properties of compression spring 144.

The elements of the springs shown in FIGS. 1 through 3 are, of course, interchangeable with one another, so that the spring element of FIG. 1 can also have rolling bearing 138 or plain bearing 129.

Parts List

125 Housing

126 Plunger

127 Rear end wall

128 Compression spring

129 Guidance member

130 Lug

131 Housing

132 Tension rod

133 Head

134 Front end wall

135 Compression spring

136 Compression spring

137 Guidance member

138 Rolling bearing element

139 Stop p1 140 Cylinder

141 Piston

142 Head

143 Shaft

144 Compression spring

145 Guidance element

What is claimed is:

1. A spring element comprising:
a substantially cylindrical housing;
a spring in the housing;
a guidance member arranged between an outer side of the spring and an inner wall of the housing to radially brace the spring.

2. The spring element as defined in claim 1, wherein the guidance member is sleeve-shaped.

3. The spring element as defined in claim 1, wherein the guidance member includes one or more rolling bearing elements enabling axial movement of the guidance member relative to the housing.

4. The spring element as defined in claim 3, wherein the guidance member is a ball-bearing bushing.

5. The spring element as defined in claim 1, wherein the guidance member is a plain bearing.

6. The spring element as defined in claim 1, further comprising an axial stop arranged in the housing for limiting axial movement of the guidance member relative to the housing.

7. The spring element as defined in claim 6, wherein the axial stop is removable.

8. The spring element as defined in claim 6, wherein the axial stop is adjustable to different axial positions along the housing.

9. The spring element as defined in claim 1, wherein at least two compression springs are arranged in axial alignment in series, the at least two compression springs being braced against one another by the guidance member (137).

10. The spring element as defined in claim 9, wherein the at least two compression springs have different spring constants.

11. The spring element as defined in claim 1, wherein the housing is a pneumatic cylinder and the spring element further comprises a piston (141) axially displaceable in the pneumatic cylinder (140), wherein the spring surrounds at least a portion of the piston.
